(19) United States
(12) Patent Application Publication
(10) Pub. No.: US 2021/0195880 A1
(43) Pub. Date: Jul. 1, 2021

(54) COLLAPSIBLE AND SELF-CLEANING CHUMMING NET

(71) Applicant: Yunior Dominguez, Hialeah, FL (US)

(72) Inventor: Yunior Dominguez, Hialeah, FL (US)

(21) Appl. No.: 16/729,199

(22) Filed: Dec. 27, 2019

(51) Int. Cl. A01K 77/00; A01K 97/02

(52) U.S. Cl. CPC A01K 77/00; A01K 97/02

(57) ABSTRACT

The present invention is a chumming net comprising one or more rod(s), rubber polymer covering for buoyancy, a connecter means, and a net. The rod or rods are connected by the connector means to form a collapsible structure to which the net is attached. In a single rod embodiment, a connector means is used to join the two ends to form the collapsible structure. In embodiments with two or more rods, the connector means is adapted to combine the rods to form a collapsible structure. An essential feature of the invention is the net which is made of flexible rubber material with non-stick or self-cleaning properties to lessen or eliminate the accumulation of smelly organic fish matter. The chumming net is capable of collapsing upon disassembly or disconnection of the rod(s) to facilitate folding for easy storage and portability.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates to generally to fishing chum nets and in particular to collapsible chumming nets for easy cleaning, maintenance, storage, and transport.

### BACKGROUND

In the fishing industry, chumming is the practice of luring certain large fish by throwing “chum” into the water. Chum consists of fish parts, including bone and blood, which large fish are attracted to by using their keen or heightened sense of smell. Chumming nets are used to capture small fish and/or sea creatures for use as bait to attract bigger fish such as marlin, tuna, tarpon or similar fish. Ordinarily, the chumming nets used by fishermen come in varying forms, sizes, and shapes, but invariably are too cumbersome to store and transport. In addition, the chumming nets tend to retain the organic matter which rots or deteriorates under the elements or due to storage conditions, causing the nets to persistently carry a foul odor. No matter the effort to clean existing chumming nets, they tend to retain the organic matter and putrid smell of rotted or deteriorating fish matter. This drastically limits the reuse of the chumming net and requires frequent replacement of chumming nets or devices. In particular, the chumming nets or devices need to be sturdy and capable of withstanding the rigors of being cast into the ocean from a moving or stationary vessel, dragged through water, and pulled back into a boat.

The present invention solves these problems by providing a chumming net that is collapsible for easy storage and transport, sturdy enough to withstand the rigors of use, and self-cleaning, making it reusable for a longer period of time. The essential features of this invention allow for the collapsing of the chumming net for storage on a boat and/or in a location minimizing sun exposure, as well as significantly reducing rapid deterioration and the retention of organic matter that creates a persistent foul odor.

### SUMMARY OF THE INVENTION

The present invention serves to improve upon existing chumming nets and address the storage, transport, and cleaning challenges currently facing the industry without sacrificing the strength and rigidity of the chumming net.

The present invention is a chumming net comprised of netting that is connected or mounted to one or more rods, where two or more rods are connected to form one complete ring that maintains the shape and integrity of the chumming net. A chumming net that comprises two or more rods, is designed for the rods to connect seamlessly by a fastening means that allows the entire assembly to function as intended. Additionally, the position of the rod(s) evenly distributes weight and improves the overall balance of the complete assembly. The net is made of durable material that does not trap chum matter (e.g. blood, bones, tissue etc.), but rather creates a non-stick surface, allowing chum matter to fall off or be rinsed off with ease. The chumming net is connected to the rod(s) by way of interweaving or looping the rod(s) through the top portion of the chumming net, creating a hoop or circular shape with the net extending 5-10 inches below the rod(s). The extended portion of the chumming net functions as an enclosed receptacle for holding the chumming matter as it is dragged through water. The rod(s) are covered by foam rubber or other material conducive to buoyancy. The foam rubber may be attached to the rod(s) in equidistant segments, with the number of segments increasing or decreasing depending on the circumference or radius of the rod(s). With two or more rods, the rods are connected via a fastening means such as universal fittings or connectors. The rod(s) may be disassembled to collapse for easy storage, transport, and/or cleaning.

### BRIEF DESCRIPTION OF THE DRAWINGS

The accompanying drawings incorporated in and forming a part of the specification, illustrate several aspects of the present invention, and together with the description serve to explain the principles of the invention. In describing the invention, reference will at times be made to the accompanying drawings in which:

FIG. 1A is a perspective view of a single rod connected by a fastening means to form a ring that is an essential component of an embodiment of the present invention;

FIG. 1B is a perspective view of a rubber foam covering designed for the single rod component of an embodiment of the present invention;

FIG. 1C is a perspective view of the assembled components of an embodiment of the present invention, including a single rod, a rubber foam covering for the single rod, and a chumming net;

FIG. 2A is a side perspective view of a single rod connected by a fastening means to form a ring that is an essential component of an embodiment of the present invention;

FIG. 2B is a side perspective view of a rubber foam covering designed for the single rod component of an embodiment of the present invention;

FIG. 2C is a side perspective view of the assembled components of an embodiment of the present invention, including a single rod, a rubber foam covering for the single rod, and a chumming net;

FIG. 3 is an enlarged perspective view of the assembled components of an embodiment of the present invention, including two rods covered by segmented rubber foam, fastening means for the rods, and a chumming net;

FIG. 4 is an enlarged front perspective view of the assembled components of an embodiment of the present invention, including two rods covered by segmented foam rubber, fastening means for the rods, and a chumming net;

FIG. 5A is a front perspective view of the assembled components of an embodiment of the present invention, including two rods covered by segmented foam rubber, fastening means for the rods, and a chumming net; and

FIG. 5B is a front perspective view of the assembled components of an embodiment of the present invention, including two rods covered by segmented foam rubber, fastening means for the rods, and a chumming net.

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

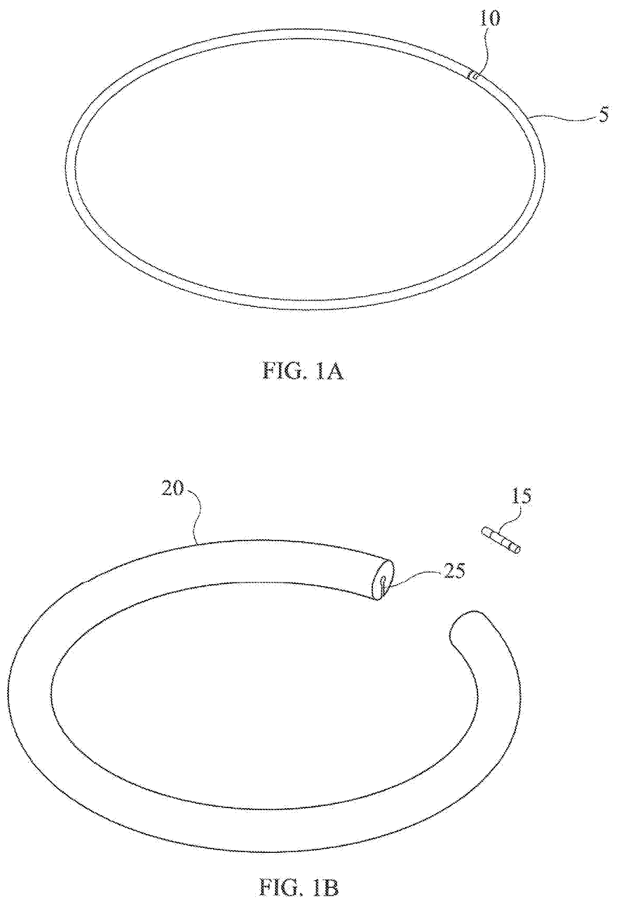

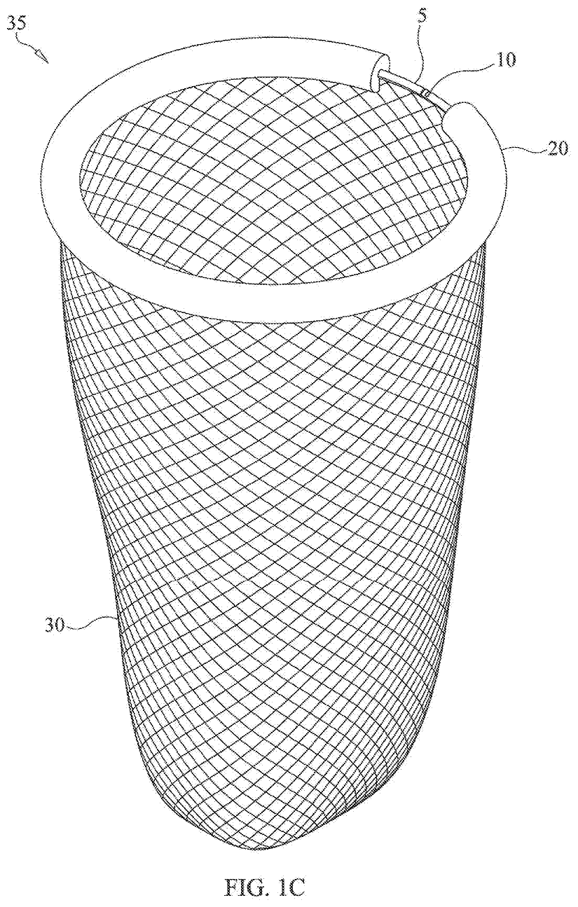

The present invention is a collapsible, self-cleaning chumming net comprised of netting that is connected or mounted to one or more rods, whereby with two or more rods, the rods are connected to each other to form one complete ring that maintains the shape and integrity of the chumming net. FIG. 1A is a perspective view of a single rod 5 connected at a connection point 10 by a fastening means 15 (as shown in FIG. 1B) to form a ring which is an essential feature of an embodiment of the present invention. The rod consists of two hollow ends to facilitate connection to form a closed circle. The fastening means 15 comprises a solid cylindric connector or pin 15 that is precisely sized to fit securely into the hollow ends of the rod 5 to form a complete circle or ring. As shown in FIGS. 1B and 1C, the rod 5 is covered by a rubber foam material 20 to facilitate the buoyancy of the assembled chumming net 35. The rubber foam covering 20 is placed over the rod 5 after the chumming net 30 is attached to the rod 5 as more clearly depicted in FIG. 1C. As shown in FIG. 1B, the rubber foam covering 20 has two ends, with each end having an opening/slit 25 that extends from the underside of one end of the rubber foam covering 20 to the other end and is easily placed over the rod 5 for a secure fit. The rubber foam covering 20 fits over the rod 5 without covering or obscuring the connection point 10. As shown in FIG. 1C, the completely assembled chumming apparatus or chumming net 35 includes a net that extends 5 to 10 inches below the rod 5.

The embodiment of the invention described above in paragraph 21 may include variations to the dimension of the assembled chumming apparatus 35. The single rod may be of varying lengths depending on the desired size of the chumming net apparatus 35. The chumming net 30 may also vary in size from small, medium, or large depending on the fishing expedition and/or need for hauling various amounts of chum. The chumming net 30, may extend less than 5 inches or more than 10 inches from the rod 5 in order to accommodate specialized needs.

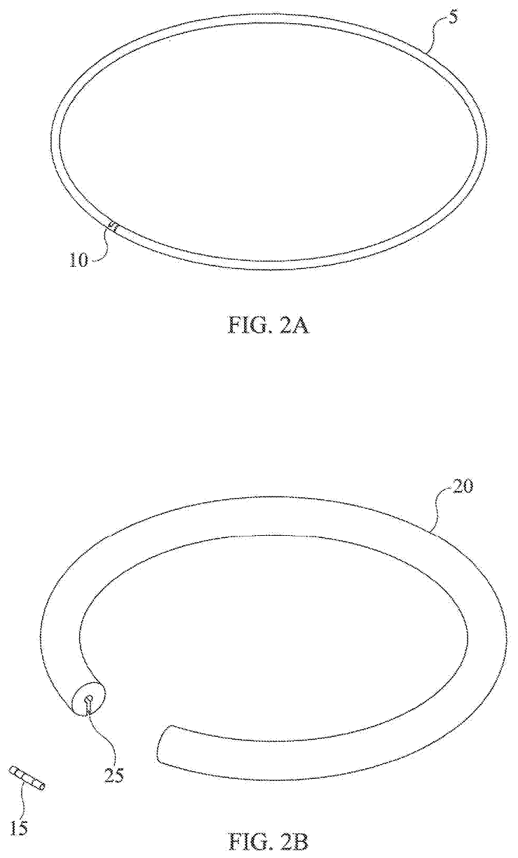

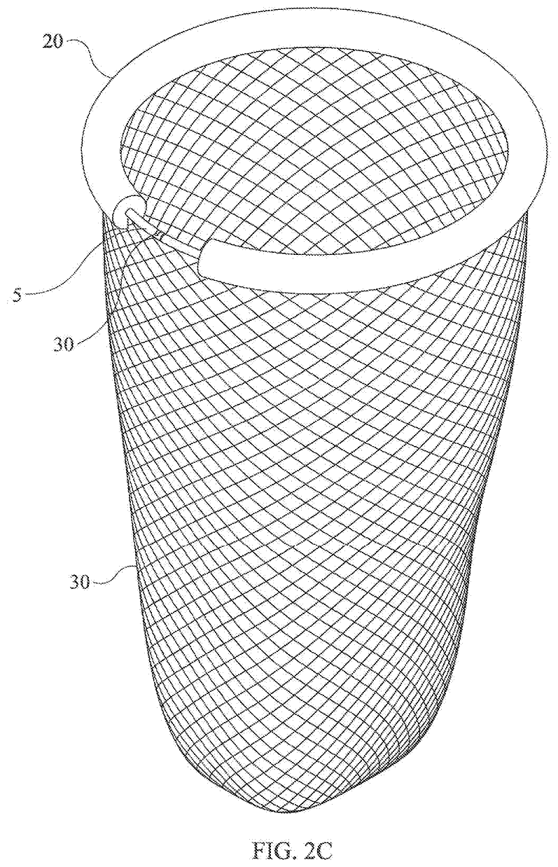

FIGS. 2A, 2B, and 2C are side perspective views of the components of an embodiment of the present invention as described above. In this embodiment of the invention, the rod 5 may be made of metal, metal alloys, PVC, other durable or flexible plastic, or any other suitable material known to one of ordinary skill in the art to which this invention belongs. As well, there may be two or more rods 5 connected together to form a complete circle as shown in FIG. 1A or other circular or polygonal shape (e.g. a square, rectangle, oval etc.). The connector or pin 15 may be made of other material, including but not limited to metals, metal alloys, PVC, other sturdy inflexible plastic or other suitable material known to one of ordinary skill in the art to which this invention belongs. Additionally, the rod 5 may be fastened by another suitable fastener (other than a solid cylindric connector or pin 15) known to one of ordinary skill in the art to which this invention belongs. The netting 30 for the invention may be made of nylon, rubber, other flexible plastic, or other suitable material known to one of ordinary skill in the art to which this invention belongs. The rubber foam covering 20 may be substituted with other suitable material that facilitates buoyancy, including but not limited to EVA (ethylene-vinyl acetate) or similar rubber polymer and/or copolymer known to one of ordinary skill in the art to which this invention belongs.

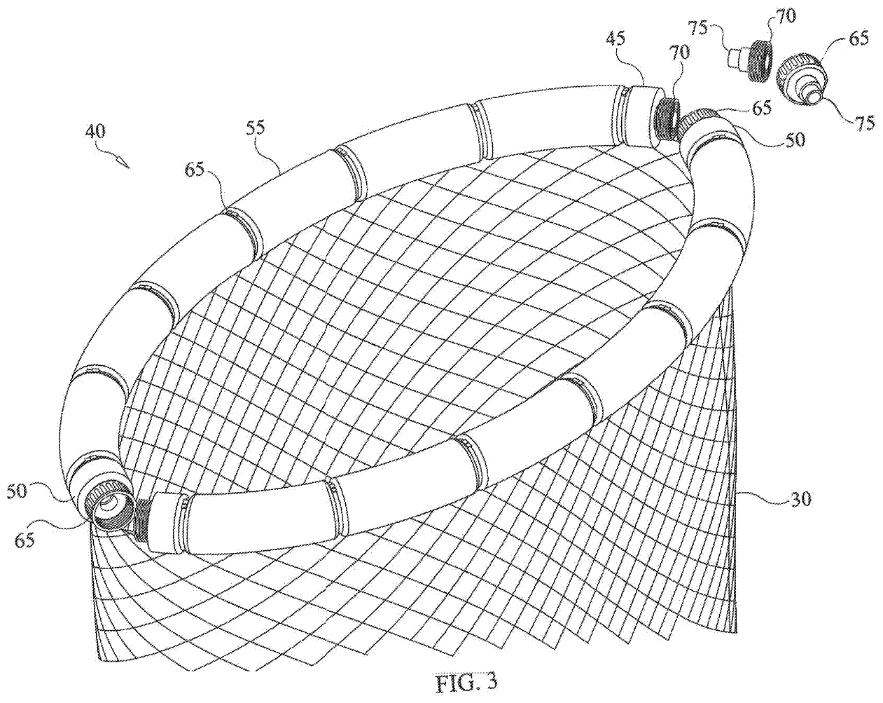

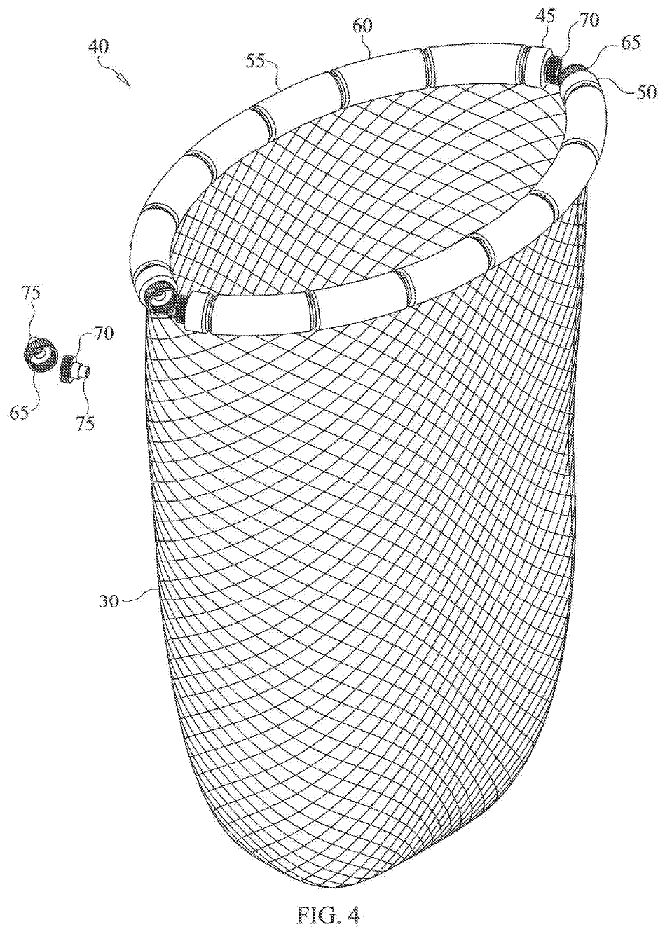

FIGS. 3, and 4 show another embodiment of the invention, the chumming net apparatus 40, whereby the rod 5 or rods as described above and depicted in FIGS. 1A and 2A, is/are covered by a segmented rubber polymer material 45, 50. In this embodiment 40, the rubber polymer coverings 45, 50 are segmented 55 and the segments are equidistant from each other and separated by separator means 60. As shown in FIG. 3A, this embodiment of the invention 40 comprises two rods 5 having a chumming net 30 attached thereto, and each rod 5 is completely covered by a rubber polymer 45 or 50 having multiple segments 55 created by separator means 60. Each rubber polymer covering 45 or 50 has connector means 65 and 70 attached at opposite ends of the covered rods 5 and rubber polymer coverings 45, 50. As shown in FIG. 3, the connector means 65 and 70 each have a point of connection 75 which directly attaches to the hollow ends of the covered rods 5, where the dimensions correspond for a secure fit. As shown in FIGS. 3 and 4, in this embodiment of the invention, the connector means 65 and 70 comprise of universal fittings whereby one end functions as a threaded screw or plug 70, while the other end functions as a threaded port 65 to facilitate a secure connection and assembly of the rods 5 covered by segmented polymers 45, 50. The net 30 remains attached to the covered rods 5 when the chumming net apparatus 40 is assembled or disassembled. The ability of the chumming net apparatus 40 to disassemble or collapse facilitates easy storage and transport, where the chumming net apparatus 40 collapses into two sections and is folded neatly into a carrying case or similar container for storage and/or transport.

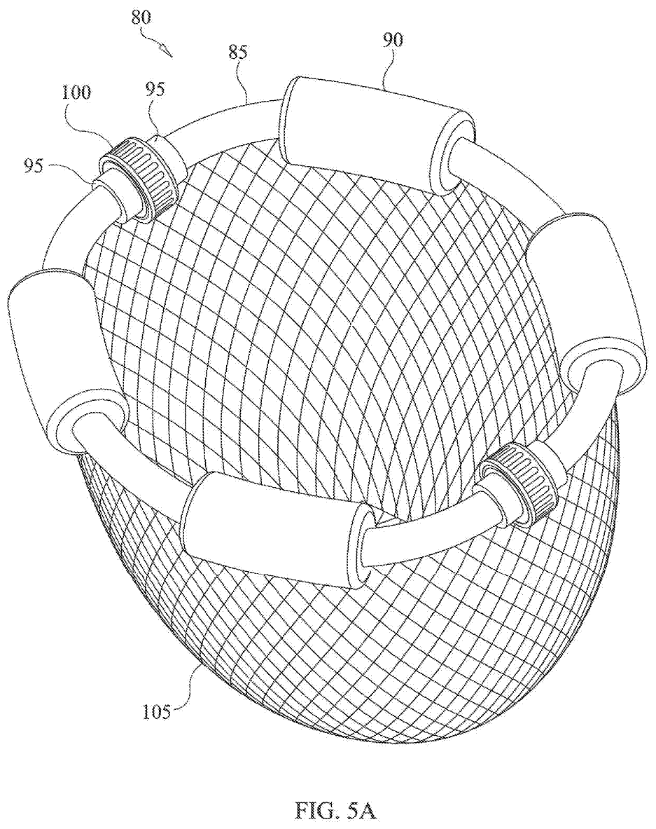

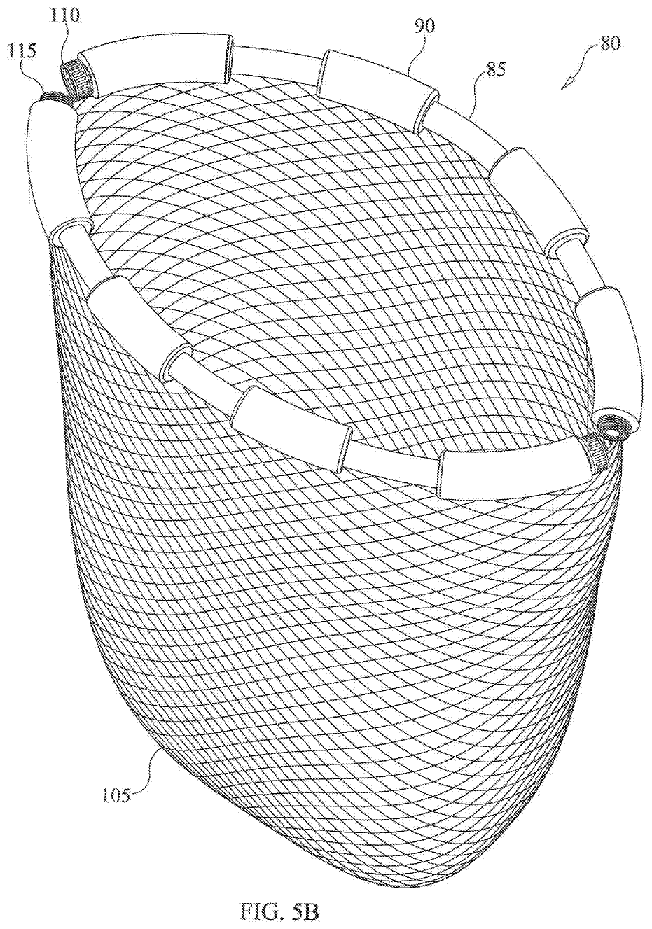

In another embodiment of this invention, as shown in FIGS. 5A and 5B, the chumming net apparatus 80 comprises two rods 85 connected to each other by fastening means 100, which rods are covered by a segmented rubber polymer material 90, and a net 105. In this embodiment, the rods 85 are not completely covered by the segmented rubber polymers 90 (As shown in FIGS. 3 and 4), rather the rods 85 and the segmented rubber polymers 90 have an alternating arrangement series whereby an exposed portion of the rod 85 is adjacent to a segment of rubber polymer 90 to the end of each rod 85. As shown in FIG. 5A, each rod 85 has connector means 95 attached to or incorporated with fastener means 100 which function to join the rods 85 together to form a closed, secure ring around the chumming net 105. FIG. 5A illustrates the assembled chumming net apparatus 80 and FIG. 5B illustrates the disconnected chumming net apparatus 80, ready to be collapsed for storage and transport. As shown in FIG. 5B, the connector means 100 referenced in FIG. 5A, comprises universal fittings 110 and 115 attached at each corresponding end of the rods 85, whereby one end of the fitting functions as a threaded port 110, while the other end functions as a threaded screw or plug 115 to facilitate a secure connection for assembly and disassembly of the rods 85. Each rod 85 has at each opposite end a threaded port 110 and a threaded screw or plug 115, which correspond accordingly for the connection of the two rods to form one closed circle or ring, resulting in the collapsible chumming net apparatus 80.

In the embodiment of the invention described above in paragraph 25 and shown in FIGS. 5A and 5B, the chumming net 80 is collapsible and capable of being folded upon disassembly/disconnection for easy storage in a case or container for transport. The rods 85 may be made of metal, metal alloys, PVC, other durable or flexible plastic, fiberglass or any other suitable material known to one of ordinary skill in the art to which this invention belongs. The net 105 may be made of nylon, rubber, other flexible plastic, or other suitable material known to one of ordinary skill in the art to which this invention belongs. In the preferred embodiment, the net 105 is made of flexible and sturdy rubber material which has inherent nonstick properties to facilitate easy removal of blood, guts, and fish particulates. This rubber material lends to the chumming net's 105 ability to not retain organic matter that may rot and cause a foul or fishy odor, rather this rubber non-stick material facilitates the removal of such organic matter, eliminating any foul odor. This non-stick feature of the rubber material that comprises the chumming net 105 is an essential element or component of the chumming net apparatus 80 which is the subject of this disclosure. Additionally, the preferred embodiment of the chumming net 105 includes rectangular shaped holes/openings when relaxed and convert to diamond shaped holes/openings upon stretching, which mechanism contributes to the self-cleaning properties of the chumming net 105. Additionally, the connector and fastening means 95, 100, 110, and 115 may be constructed from PVC, metal, fiber glass, or other moldable plastic known to one of ordinary skill in the art to of plug and port type fittings.

The embodiments described in this disclosure may also include non-collapsible iterations, whereby the one or more rods that create the structure of the chumming net apparatus do not disconnect to facilitate collapsibility. Therefore, the rod or rods remained connected and not capable of being disconnected while retaining the integrity of the chumming net structure. The non-collapsible chumming net would still maintain other features, including its self-cleaning, non-stick rubber net component.

As various changes may be made in the above-described subject matter without departing from the scope and the spirit of the invention, it is intended that all subject matter contained in the above description, or shown in the accompanying drawings, will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A collapsible and self-cleaning chumming net comprising:
a single rod, having two hollow ends; and
a cylindrical fastening means, having two solid ends that fit into the hollow ends of the single rod, functioning to connect the ends of the rod at a connection point to form a circle; and whereby the ends of the rod may be disconnected at the connection point to facilitate collapsibility; and
a net that is mounted onto the single rod, which net is made of a non-stick rubber polymer that does not retain organic matter, and having polygonal shaped openings that create a mesh pattern; and
a rubber foam covering that is placed over the rod to facilitate buoyancy, and leaving the connection point exposed.

2. The collapsible and self-cleaning chumming net in claim 1 whereby the rubber foam covering is made from ethylene-vinyl acetate.

3. A collapsible and self-cleaning chumming net comprising:
two or more rods, each rod having two hollow ends; and
cylindrical fastening means, each having two solid ends that fit into the hollow ends of each rod, functioning to connect the ends of the rods at connection points to form a circle; and whereby the rods may be disconnected at the connection point to facilitate collapsibility; and
a net that is mounted onto the rods, which net is made of a non-stick rubber polymer that does not retain organic matter, and having polygonal shaped openings that create a mesh pattern; and
a rubber foam covering that is placed over the rods to facilitate buoyancy, and leaving at least one connection points exposed.

4. The collapsible and self-cleaning chumming net in claim 3 whereby the two or more rods connect to form a polygonal structure.

5. The collapsible and self-cleaning chumming net in claim 3 whereby the rubber foam covering is made from ethylene-vinyl acetate.

6. A collapsible and self-cleaning chumming net comprising:
a single rod; and
segmented rubber polymer material covering the rod to facilitate buoyancy, whereby the segments are of equal size and are separated equidistant from each other; and
a threaded plug and port fastening means connected to each end of the rod, whereby the threaded plug is screwed into the threaded port for a secure connection of the rod at a connection point located at the ends of the rod to form a circle; and whereby the ends of the rod may be disconnected at the connection point to facilitate collapsibility; and
a net made of a non-stick rubber polymer that does not retain organic matter and having polygonal shaped openings that create a mesh pattern; which net is mounted onto the single rod covered by the segmented rubber polymer material.

7. The collapsible and self-cleaning chumming net in claim 6 whereby the rubber foam covering is made from ethylene-vinyl acetate.

8. A collapsible and self-cleaning chumming net comprising:
two or more rods; and
segmented rubber polymer material covering the rod to facilitate buoyancy, whereby the segments do not completely cover the rods, but have an alternating arrangement series of rubber polymer material and rod, exposing portions of the rods; and
a threaded plug and port fastening means connected to the corresponding end of each of the rods, whereby the threaded plug is screwed into the threaded port for a secure connection of the rods at the corresponding connection points located at the ends of the rods to form a circle; and whereby the rods may be disconnected at the connection point to facilitate collapsibility; and
a net made of a non-stick rubber polymer that does not retain organic matter and having polygonal shaped openings that create a mesh pattern; which net is mounted onto the rods covered in an alternating arrangement series of segmented rubber polymer material.

9. The collapsible and self-cleaning chumming net in claim 8 whereby the two or more rods connect to form a polygonal structure.

10. The collapsible and self-cleaning chumming net in claim 8 whereby the rubber foam covering is made from ethylene-vinyl acetate.

11. A non-collapsible and self-cleaning chumming net comprising:
one or more rod(s), each rod having two hollow ends; and
a cylindrical fastening means, having two solid ends that fit into the hollow ends of each rod, functioning to connect the ends of the rod(s) at a connection point to form a circle; and whereby the ends of the rod(s) may be disconnected at the connection point to facilitate collapsibility; and
a net that is mounted onto the rod(s), which net is made of a non-stick rubber polymer that does not retain organic matter, and having polygonal shaped openings that create a mesh pattern; and
a rubber foam covering that is placed over the rod(s) to facilitate buoyancy, and leaving the connection point exposed.

12. The non-collapsible and self-cleaning chumming net in claim 11 whereby the one or more rods connect to form a polygonal structure.

13. The non-collapsible and self-cleaning chumming net in claim 11 whereby the rubber foam covering is made from ethylene-vinyl acetate.

14. A non-collapsible and self-cleaning chumming net comprising:
one or more rods; and
segmented rubber polymer material covering the rod(s) to facilitate buoyancy, whereby the segments do not completely cover the rods, but have an alternating arrangement series of rubber polymer material and rod, exposing portions of the rod(s); and
a threaded plug and port fastening means connected to the corresponding end of each of the rod(s), whereby the threaded plug is screwed into the threaded port for a secure connection of the rod(s) at the corresponding connection points located at the ends of the rod(s) to form a circle; and whereby the rod(s) may be disconnected at the connection point to facilitate collapsibility; and
a net made of a non-stick rubber polymer that does not retain organic matter and having polygonal shaped openings that create a mesh pattern; which net is mounted onto the rod(s) covered in an alternating arrangement series of segmented rubber polymer material.

15. The non-collapsible and self-cleaning chumming net in claim 14 whereby the two or more rods connect to form a polygonal structure.

16. The non-collapsible and self-cleaning chumming net in claim 14 whereby the rubber foam covering is made from ethylene-vinyl acetate.
